(19) United States
(12) Patent Application Publication
(10) Pub. No.: US 2008/0206511 A1
(43) Pub. Date: Aug. 28, 2008

(54) SYNTHETIC MICROFIBER MATERIAL

(75) Inventor: Terrence Treacy, Mansfield, TX (US)

Correspondence Address: Terrence Treacy, 7108 Twin Oaks Court, Mansfield, TX, 76063, US

(73) Assignee: TxF PRODUCTS, INC., Arlington, TX (US)

(21) Appl. No.: 11/679,994

(22) Filed: Feb. 28, 2007

(51) Int. Cl. B32B 3/02; D21H 15/00

(52) U.S. Cl. 428/85; 162/157.1

(57) ABSTRACT

An apparatus comprising a plurality of first threads coupled to and extending from a substrate, and a plurality of second threads coupled to and extending from the substrate, wherein each of the plurality of first threads comprises a plurality of synthetic filaments, each of the plurality of filaments comprises a plurality of synthetic microfibers, each of the plurality of second threads is adjacent to at least one of the plurality of first threads, and each of the plurality of second threads does not comprise synthetic microfibers.

### BACKGROUND OF THE DISCLOSURE

Microfiber textile materials are made from a combination of a microfiber material and non-microfiber material. Some such combination materials suffer problems attributable to the mechanical properties of the microfiber component. For example, the tendency for microfiber material to cling or “stick” to a surface prevents the combination material from easily gliding across a surface.

To prevent the combination material from establishing too much contact with the surface, previous combination materials used a large amount of non-microfiber material. However, non-microfiber material does not hold dirt and dust as effectively as microfiber material. That is, the smaller fibers of the microfiber component improve the ability of the combination material to hold dirt and dust. Consequently, increasing the ratio of the non-microfiber material to the microfiber material in the combination material allows the combination material to more easily slide across a surface being cleaned or otherwise treated, but also decreases the ability of the combination material to retain dirt, dust and/or other contaminates removed from the surface.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a sectional view of at least a portion of apparatus demonstrating one or more aspects of the present disclosure.

FIG. 2 is a block-diagram of at least a portion of a method of manufacture according to one or more aspects of the present disclosure.

FIG. 3 is a sectional view of at least a portion of a microfiber demonstrating one or more aspects of the present disclosure.

FIG. 4 is an exploded sectional view of the microfiber shown in FIG. 3.

FIGS. 5a-5d are schematic views of microfiber and threads demonstrating one or more aspects of the present disclosure.

FIG. 6 is a schematic view of apparatus demonstrating one or more aspects of the present disclosure.

FIG. 7 is a perspective view of apparatus demonstrating one or more aspects of the present disclosure.

FIG. 8 is a perspective view of apparatus demonstrating one or more aspects of the present disclosure.

FIG. 9 is . . . .

FIG. 10 is . . . .

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact.

As employed herein, the term “microfiber” may be a technical term that may indicate that a fiber is one denier or smaller. Such microfibers and larger fibers can be employed within the scope of the present disclosure. For example, a microfiber or fiber may be about 0.2 denier after undergoing a splitting process described herein or otherwise. However, lower denier values are also within the scope of the present disclosure. Moreover, microfibers and other fibers employed according to one or more aspects of the present disclosure may substantially comprise polyester, polyamide, nylon, acrylic and/or other synthetic and non-synthetic materials.

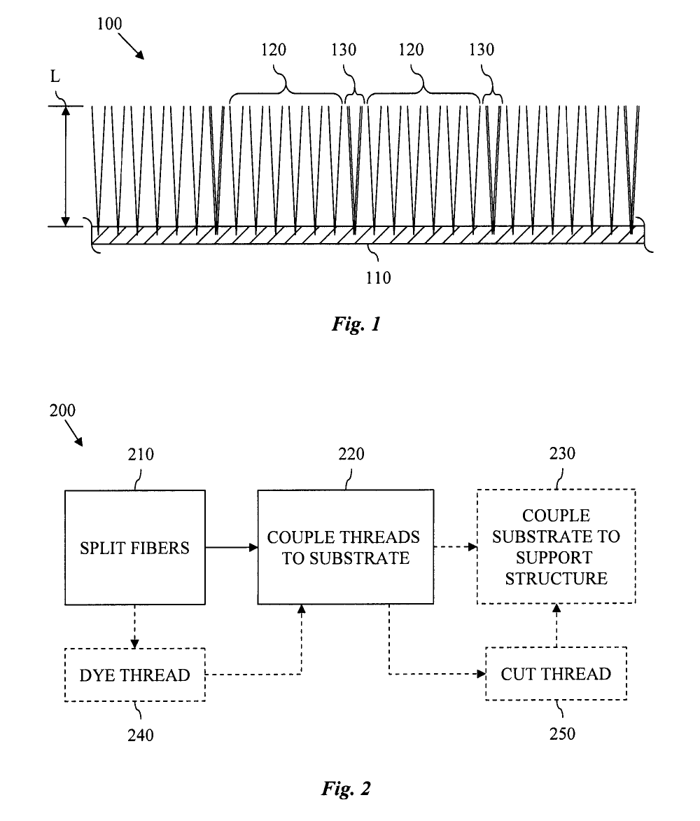

Referring to FIG. 1, illustrated is a sectional view of a synthetic microfiber material 100 demonstrating one or more aspects of the present disclosure. The synthetic microfiber material 100 may include a substrate 110, one or more pluralities of first threads 120, and one or more pluralities of second threads 130. In the exemplary embodiment shown in FIG. 1, two of the pluralities of first threads 120 are labeled, and two of the pluralities of second threads 130 are labeled.

The substrate 110 may substantially comprise polyester, polyamide, nylon, acrylic and/or other materials. The substrate 110 may be flexible or substantially rigid. The thickness of the substrate 110 may vary among the myriad embodiments within the scope of the present disclosure and, within an individual embodiment, may be substantially constant or vary along the length of the substrate 110. The substrate 110 may comprise a single structure or component of a single composition, such as in the exemplary embodiment depicted in FIG. 1. Alternatively, the substrate 110 may comprise an outer shell or skin and a substantially flexible internal filling or reservoir, such that the substrate 110 is “spongy” and/or capable of absorbing liquids. In an exemplary embodiment, the substrate 110 comprises a woven or otherwise formed grid or matrix of flexible material, thereby having a plurality of openings and/or recesses therein.

Each of the pluralities of first threads 120 may comprise a plurality of microfibers. For example, each of the pluralities of first threads 120 may comprise between about 50 and about 150 filaments, and each filament may comprise between about eight and about sixteen microfibers. In one embodiment, each thread comprises 72 filaments. However, one or more aspects of the present disclosure may be applicable or readily adaptable to embodiments including threads comprising less than about 50 filaments, threads comprising greater than about 150 filaments, filaments comprising less than about eight microfibers, and/or filaments comprising greater than about sixteen microfibers.

Each of the pluralities of first threads 120 may generally have a denier value ranging between about 0.01 and about 50. In one embodiment, each of the pluralities of first threads 120 may have a denier value ranging between about 0.09 and about 17. In another embodiment, each of the pluralities of first threads 120 may have a denier value ranging between about 0.1 and about 30. In yet another embodiment, each of the pluralities of first threads 120 may have a denier value ranging between about 0.2 and about 15. Example denier values of the filaments within the scope of the present disclosure include 2 denier, 3 denier, and 5 denier (pre-split filaments). The example denier values and ranges described above may be applicable to the raw microfiber material prior to a fiber splitting process employed during the manufacture of the each of the pluralities of first threads 120, and/or to the microfiber material after such splitting process. Moreover, denier values other than those described above are also within the scope of the present disclosure.

Each of the pluralities of second threads 130 may substantially comprise polyester, polyamide, nylon, acrylic and/or other synthetic or non-synthetic materials. In one embodiment, each of the pluralities of second threads 130 may substantially comprise a non-microfiber material. In another embodiment, each of the pluralities of second threads 130 may substantially comprise a microfiber material comprising a different polymeric composition than each of the pluralities of first threads 120. Each of the pluralities of second threads 130 may additionally or alternatively comprise other materials not explicitly described above.

Each of the pluralities of first and second threads 120 and 130 are coupled to and extend from the substrate 110. For example, each of the pluralities of first and second threads 120 and 130 may be woven into the substrate 110 such that the ends of each of the pluralities of first and second threads 120 and 130 extend from the substrate 110, possibly in a substantially V-shaped formation. Other ways of coupling each of the pluralities of first and second threads 120 and 130 to the substrate 110 are also within the scope of this disclosure. For example, one or more of the pluralities of first and second threads 120 and 130 may be secured to the substrate 110 via adhesive, chemical bonding, interference fit, stitching, sewing, and/or other means. One or more of the pluralities of first and second threads 120 and 130 may alternatively be integral to the substrate 110.

Each of the first and second pluralities of threads 120 and 130 may substantially extend to a common distance L from the substrate 110. For example, the distance L to which each of the first and second pluralities of threads 120 and 130 extend from the substrate 110 may range between about ______ mm and about ______ mm, although other values are also within the scope of the present disclosure.

Moreover, one or more of each of the first and second pluralities of threads 120 and 130 may alternatively extend to varying distances from the substrate 110 within the scope of the present disclosure. For example, each of the first pluralities of threads 120 may extend from the substrate 110 to a first distance, whereas each of the second pluralities of threads 130 may extend from the substrate 110 to a second distance, wherein the first and second distances are not equal. In one such embodiment, the distance to which each of the first pluralities of threads 120 extends from the substrate 110 may be about 25% greater than the distance to which each of the second pluralities of threads 130 extends from the substrate 110.

Each of the pluralities of first and second threads 120 and 130 may be arranged such that each plurality of second threads 130 interposes two pluralities of first threads 120, although several pluralities of first threads 120 may be adjacent one another in series. In an exemplary embodiment, each plurality of second threads 130 may comprise a single row of the second threads and each plurality of first threads 120 may comprise six rows of the first threads. Thus, the synthetic microfiber material 100 may comprise a substantially regular pattern of alternating pluralities of first and second threads 120 and 130, although each of the pluralities of first threads 120 may be about six times or otherwise substantially larger than each of the pluralities of second threads 130. The pluralities of first threads 120 may comprise about 70% to 80% of the total number of threads comprising the pluralities of first and second threads 120 and 130, or the pluralities of first threads 120 may comprise about 80% to 90% of the total number of threads comprising the pluralities of first and second threads 120 and 130. However, other combinations of first and second plurality of threads 120 and 130 are also within the scope of the present disclosure. Other such examples include where the pluralities of first threads 120 comprise about 70%, 75%, 80% or 85% of the total number of threads comprising the pluralities of first and second threads 120 and 130

Referring to FIG. 2, illustrated is a block-diagram depicting at least a portion of a manufacturing method 200 according to one or more aspects of the present disclosure. The method 200 includes a step 210 in which raw microfibers contained in the filaments of a thread are split. In some embodiments of the present disclosure, a bi-component filament design may be employed. For example, polyester and nylon or two otherwise separate materials may be joined during thread or yarn manufacture. In other embodiments of the present disclosure, all the filaments may be made of one material, such as polyester, nylon, acrylic and/or any other synthetic fibers. Moreover, filament designs other than those described above are also within the scope of the present disclosure.

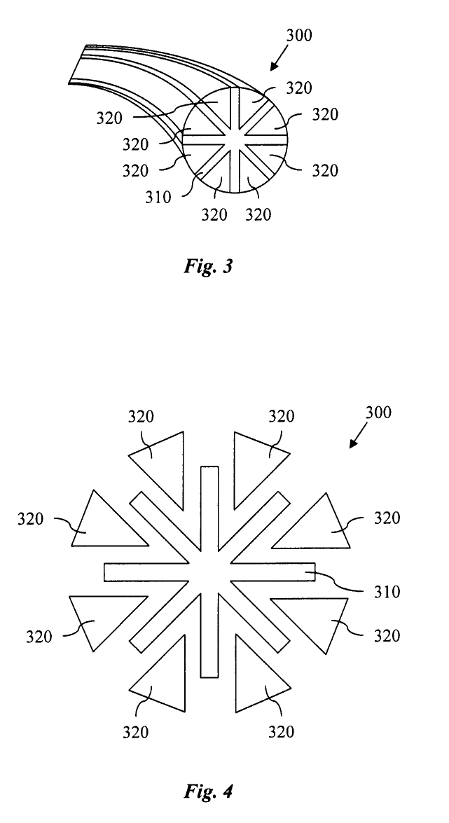

For example, referring to FIG. 3, a raw microfiber 300 may include a central portion 310 and a plurality of outer segments 320. The central portion 310 may have a spoked or star-shaped cross-sectional geometry, such as in the exemplary embodiment shown in FIG. 3. Consequently, the outer segments 320 may each have a wedge-shaped cross-sectional geometry, such as in the exemplary embodiment shown in FIG. 3. However, the scope of the present disclosure is not limited to microfibers having portions according to the cross-sectional geometry examples shown in FIG. 3. Moreover, the number of outer segments 320 in each fiber 300 may be less than or greater than the eight segments 320 shown in FIG. 3. The central portion 310 and the outer segments 320 may substantially comprise polyester, polyamide, nylon, and/or other materials. For example, the central portion 310 may substantially comprise polyester and the outer segments 320 may each substantially comprise nylon.

Referring to FIGS. 2 and 3, collectively, the outer segments 320 may be partially or completely separated from the central portion 310 during the fiber splitting step 210 of method 200. The splitting step 210 may include agitating the fiber 300 in the presence of heat and/or a chemical solution selected to separate the outer segments 320 from the central portion 310. For example, the chemical solution may substantially comprise lye and/or other caustic compositions. The heat and/or chemical solution may also be employed in the absence of agitation. As a result of the splitting process, as shown in the embodiment depicted in FIG. 4, the outer segments 320 may become substantially or completely separated from the central portion 310. However, in some embodiments, the outer segments 320 may become only partially separated from the central portion 310.

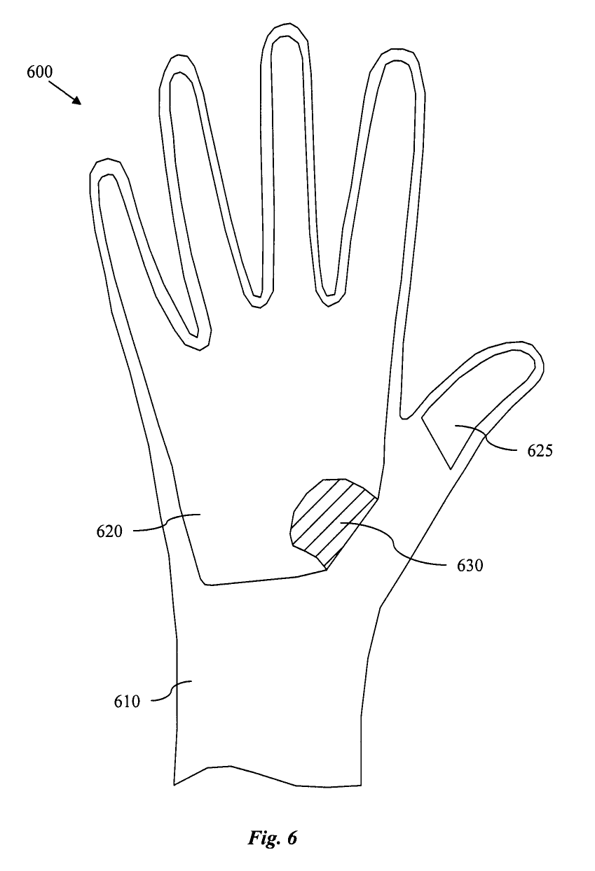

After the splitting process of step 210, a first plurality of threads comprising each of the microfiber threads that resulted from the splitting process and a second plurality of threads may be coupled to a substrate (e.g., the substrate 110 shown in FIG. 1) in a step 220. Thereafter, in an optional step 230, a support structure may be coupled to the substrate. For example, a substantially glove-shaped support structure such as that shown in FIG. 6 (and described in more detail below) may be attached to the substrate opposite the first and second plurality of threads.

The method 200 may also include an optional step 240 in which some or all of the first and second plurality of threads are dyed one or more colors before each of the first and second plurality of threads are coupled to the substrate. The dye process of step 240 may also or alternatively be performed after each of the first and second plurality of threads are coupled to the substrate in step 220 and/or before the splitting process of step 210.

The method 200 may also include an optional step 250 in which some or all of the microfiber threads are cut into separate threads before coupling the substrate to a support structure in step 230. This thread cutting step 250 may be performed after the coupling process of step 220 or elsewhere in the method 200. The thread cutting step 250 may optionally be performed substantially simultaneously with, and perhaps as a consequence of, the coupling process of step 220.

Some terms employed herein may have common industrial meanings. For example, “fiber” may mean material that is generated by splitting a filament. “Filament” may refer to either pre-split material that contains microfibers, or a filament may refer to a synthetic material that is small and cannot be split. “Thread” may mean the combination of multiple filaments that may be woven into a cloth (pre-split) or coupled to a substrate (post-split). Threads may come on a spool and may be used to make a tangible product. Nonetheless, the scope of the present disclosure is not limited to the common industrial meanings these terms may have.

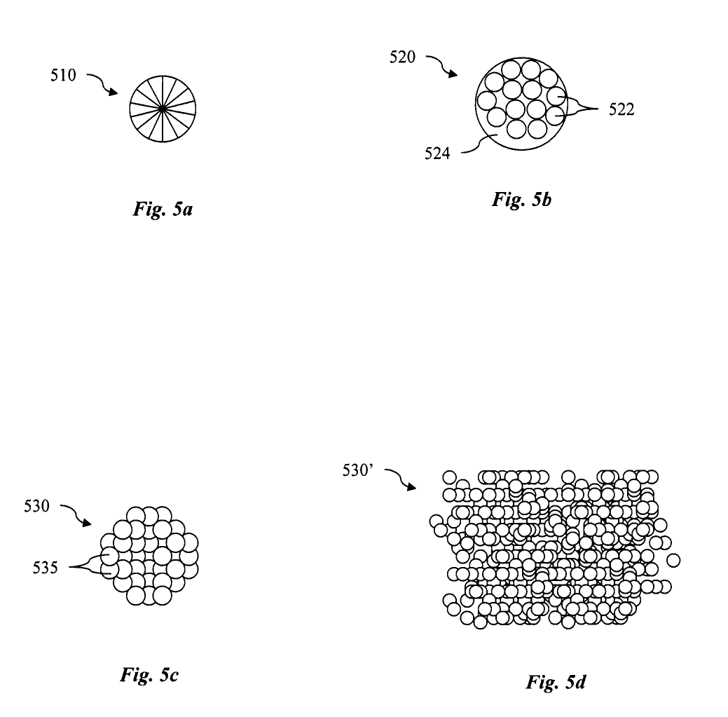

FIGS. 5a-5d are schematic diagrams of various microfiber material manufacturing stages according to aspects of the present disclosure. FIG. 5a is a schematic diagram of a single bi-component filament 510. The bi-component filament design is discussed above, and is illustrated in more detail in FIGS. 3 and 4. FIG. 5b is a schematic diagram of a single “islands in the sea” filament 520, in which a plurality of substantially round or otherwise shaped microfibers (the “islands”) 522 are encased in another material (the “sea”) 524. The islands 522 may comprise polyester and/or other synthetics. The islands 522 within a single filament 520 may each comprise the same material. Alternatively, a single filament 520 may comprise islands 522 of more than one material.

FIG. 5c is a microfiber thread 530 comprising a plurality of microfiber filaments 535. For example, 50 to 100 single filaments 535, each possibly being about 3 denier, may be combined to create the thread 530, which may result in about 150 denier. One or more of the single filaments 535 combined to form the thread 530 shown in FIG. 5c may be substantially similar or identical to the filament 510 shown in FIG. 5a and/or the filament 520 shown in FIG. 5b.

Referring to FIG. 5d, illustrated is a plurality 530′ of the threads 530 shown in FIG. 5c after being woven together to form a cloth that is then subjected to a splitting process to release the microfibers from within the filaments in the thread used to make the cloth. For example, if a filament employs the “islands in the sea” approach, then upon splitting the filament, the sea may be dissolved, leaving the small islands. The “islands in the sea” design may yield as many as 1200 microfibers from one strand of yarn consisting of about 70 filaments. In one embodiment, each thread comprises 72 filaments and the splitting process releases 1152 microfibers, resulting in a denier of about 0.2. After splitting the filaments, the resulting cloth may be dyed and then woven or otherwise secured to a substrate (such as shown in FIG. 1) or other apparatus within the scope of the present disclosure.

Referring to FIG. 6, illustrated is a schematic view of an apparatus 600 demonstrating one or more aspects of the present disclosure. The apparatus 600 may be referred to herein as a glove. The glove 600 may include a substantially glove-shaped support structure 610 and a synthetic microfiber material 620 attached to the support structure 610. The glove 600 may also include a support material 630 interposing the synthetic microfiber material 620 and the support structure 610, although some embodiments within the scope of the present disclosure may omit the support material 630. In the example shown in FIG. 6, a portion of the synthetic microfiber material 620 is removed to reveal the underlying support material 630 (the hatched area).

The support structure 610 may substantially comprise latex and/or other conventional or future-developed materials. The synthetic microfiber material 620 may be substantially as described above with regard to FIG. 1. The support material 630 may substantially comprise a water-resistant foam and/or other materials. The synthetic microfiber material 620 and the support material 630 may each have a shape substantially conforming to the hand-shaped profile of the support structure 610. In the exemplary embodiment shown in FIG. 6, the glove 600 includes an additional portion 625 which is substantially similar in composition and manufacture as the synthetic microfiber material 620 and the support material 630 (when used).

The glove 600 may be assembled by conventional and/or future-developed processes. For example, the synthetic microfiber material 620 may be adhered or otherwise secured to the support material 630. The synthetic microfiber material 620 and the support material 630 may then be temporarily secured to an assembly jig having a similar shape. The support structure 610 is then placed around the jig, synthetic microfiber material 620 and support material 630 and adhered or otherwise coupled to the support material 630. The assembly jig is then removed, and the glove 600 is turned inside-out such that the synthetic microfiber material 620 is now positioned external to the support structure 610. The support structure 610, the microfiber portion 620, and the support material 630 may be coupled using a water-resistant adhesive, although other means of coupling the elements of the glove 600 are also within the scope of this disclosure. In one embodiment, the glove-shaped support structure 610 is coupled directly to the surface of the microfiber portion 630 opposite the threads, and there is no support material 620.

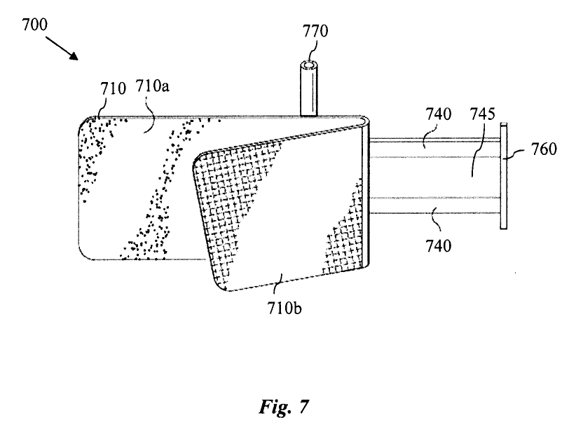

Referring to FIG. 7, illustrated is a perspective view of an apparatus 700 demonstrating one or more aspects of the present disclosure. The apparatus 700 may be referred to herein as a mop head. The mop head 700 may include a mop pad 710. The mop pad 710 may be a substantially flat, substantially rectangular pad (among other possible shapes) comprising a first surface 710a and a second surface 710b. At least a portion of the mop pad 710 may be substantially similar to the apparatus 100 shown in FIG. 1. For example, the first surface 710a of the mop pad 710 may substantially comprise a synthetic microfiber material as described above with respect to FIG. 1. All or a portion of the second surface 710b may substantially comprise hook-and-loop fastening material (e.g., “VELCRO”).

The mop head 700 may further comprise a support structure 740. The support structure 740 may include a portion 745 comprising hook-and-loop fastening material (e.g., “VELCRO”) configured to cooperate with the fastening material on the second surface 710b of the mop pad 710 to detachably secure the mop pad 710 to the structure 740. The mop head 700 may also comprise one or more end-members 760 and/or means 770 for detachably coupling with a handle (not shown). Other means for detachably coupling the mop pad 710 to the support structure 740, such as elastic bands, are also within the scope of the present disclosure.

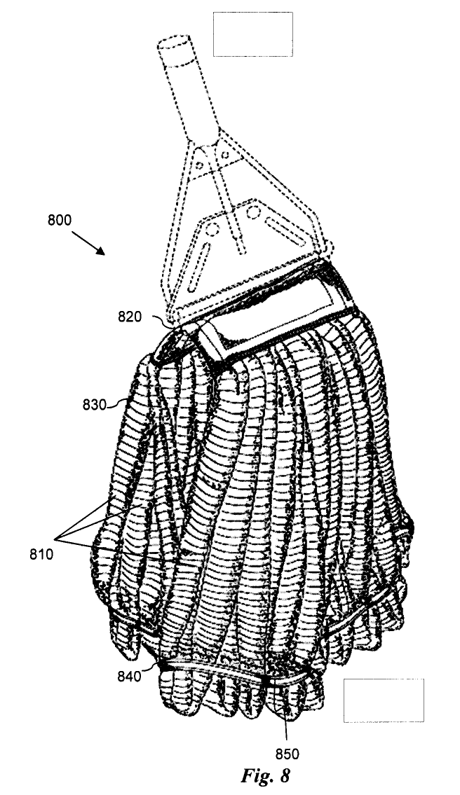

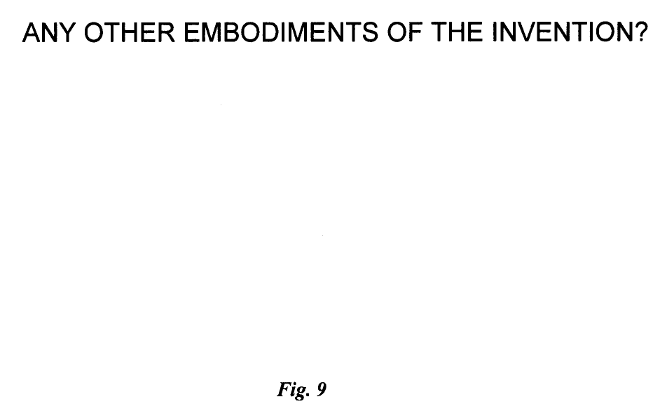

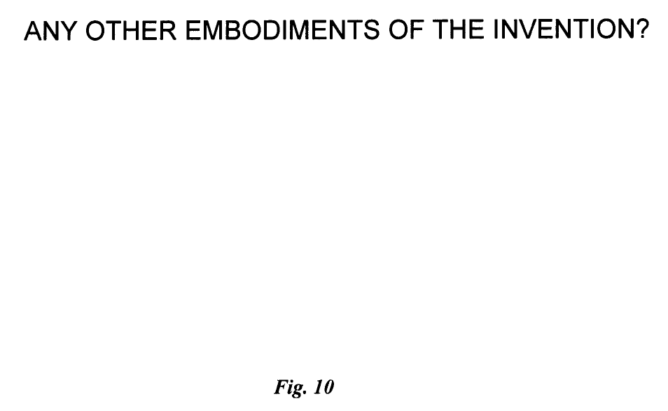

Referring to FIG. 8, illustrated is a side view of an apparatus 800 demonstrating one or more aspects of the present disclosure. The apparatus 800 may also be referred to herein as a mop head. The mop head 800 may comprise a plurality of substantially tubular looped absorptive strands 810 coupled together at a central portion 820. Each of the plurality of strands 810 may substantially comprise a synthetic microfiber material as described above with respect to FIG. 1. Each of the plurality of strands 810 may be banded along at least a portion 830 of each of the plurality of strands 810. Each of the plurality of strands 810 may be bound to at least one adjacent strand 810 along at least a portion 840 of each of the plurality of strands 810 distal from the central portion 820. For example, a ribbon 850 may be woven across at least the portion 840 of each of the plurality of strands 810 to bind each of the plurality of strands 810 to an adjacent strand 810. The central portion 820 may further comprise nylon and/or other materials to add structural strength to the central portion 820 of the mop head 800. The central portion 820 may be detachably couplable to a handle (not shown).

In view of all of the above and the Figures, it should be readily apparent that the present disclosure introduces an apparatus comprising: (1) a plurality of first threads coupled to and extending from a substrate, wherein each of the plurality of first threads comprises a plurality of synthetic filaments, and each of the plurality of filaments comprises a plurality of synthetic microfibers; and (2) a plurality of second threads coupled to and extending from the substrate, wherein each of the plurality of second threads is adjacent to at least one of the plurality of first threads, and wherein each of the plurality of second threads does not comprise synthetic microfibers. Each of the plurality of second threads may be adjacent to at least two of the plurality of first threads. The plurality of first threads may comprise about six first threads. Each of the plurality of first threads and each of the plurality of second threads may extend to about a common distance from the substrate. The plurality of first threads may comprise between about 70% and about 80% of the sum of the plurality of first threads and the plurality of second threads, or the plurality of first threads may comprise between about 80% and about 90% of the sum of the plurality of first threads and the plurality of second threads. The plurality of first threads may comprise about 70%, 75%, 80% or 85% of the sum of the plurality of first threads and the plurality of second threads. Each of the plurality of second threads may substantially comprise nylon. Each of the pluralities of first and second threads may have first and second free ends and a central portion coupled to the substrate. Each of the plurality of synthetic microfibers may substantially comprise polyester. The plurality of synthetic microfibers may comprise a plurality of bi-component microfibers and/or a plurality of “islands in the sea” microfibers. The apparatus may further comprise a support material attached to the substrate opposite the pluralities of first and second threads. The apparatus may further comprise a support structure attached to the substrate opposite the pluralities of first and second threads. The apparatus may further comprise a substantially gloved-shaped support structure attached to the substrate opposite the pluralities of first and second threads. The apparatus may further comprise: (1) a first hook-and-loop fastener portion coupled to the substrate opposite the pluralities of first and second threads; and (2) a support structure comprising a substantially planar rectangular member and a second hook-and-loop fastener portion coupled to the member and configured to cooperate with the first hook-and-loop fastener portion to detachably couple the substrate with the support structure. The substrate may be one of a plurality of substantially tubular substrates and the pluralities of first and second threads may extend radially outward from each of the plurality of substantially tubular substrates.

The present disclosure also introduces a method of manufacturing an apparatus comprising: (1) processing a plurality of first threads, wherein each of the plurality of first threads comprises a plurality of synthetic filaments, wherein each of the plurality of synthetic filaments comprises a plurality of synthetic microfibers, and wherein processing the plurality of first threads comprises splitting each of the plurality of filaments to release the plurality of microfibers therein; and (2) coupling the plurality of first threads and a plurality of second threads to a substrate, wherein each of the plurality of second threads is adjacent to at least one of the plurality of first threads, and wherein each of the plurality of second threads does not comprise synthetic microfibers. Each of the plurality of second threads may be adjacent to at least two of the plurality of first threads. The processing may be performed before the coupling. Each of the pluralities of first and second threads may have first and second free ends and a central portion coupled to the substrate, wherein coupling the pluralities of first and second threads to the substrate may comprise weaving each of the pluralities of first and second threads into the substrate. Splitting each of the plurality of filaments may comprise exposing the filaments to at least one of heat and a chemical solution. Splitting each of the plurality of filaments may comprise agitating the filaments in the presence of at least one of heat and a chemical solution. The method may further comprise adding color to at least one of the pluralities of first and second threads.

The present disclosure also introduces an apparatus comprising: (1) a substrate; (2) a first plurality of threads each substantially comprising polyester extending from the first surface of the substrate, wherein each of the first plurality of threads comprises a plurality of filaments, and wherein each of the plurality of filaments comprises a plurality of microfibers; and (3) a second plurality of threads each substantially comprising nylon extending from the second surface of the substrate, wherein the first and second plurality of threads are coupled to the substrate, wherein about six of the first plurality of threads are adjacent to at least one or two of the second plurality of threads, each of the first and second plurality of threads have first and second free ends and a central portion woven into the substrate, each of the first and second plurality of threads extend to about a common distance from the first surface of the substrate, and the first plurality of threads comprises a percentage of the sum of the first and second plurality of threads ranging from about 70% to 80%, or the first plurality of threads comprises a percentage of the sum of the first and second plurality of threads ranging from about 80% to 90%.

The present disclosure also introduces a method of manufacturing an apparatus comprising: (1) processing a first plurality of threads substantially comprising polyester, wherein each of the first plurality of threads comprises a plurality of synthetic filaments, each of the plurality of filaments comprises a plurality of synthetic microfibers, and processing the plurality of threads comprises splitting each of the plurality of filaments to release the plurality of microfibers therein by agitating the filaments in the presence of at least one of heat and a chemical solution; (2) weaving the first plurality of threads and a second plurality of threads substantially comprising nylon into a substrate after the processing is performed, wherein each of the second plurality of threads is adjacent to at least six of the first plurality of threads, each of the first and second plurality of threads have first and second free ends and a central portion woven into the substrate, each of the first and second plurality of threads extend to about a common distance from a surface of the substrate, and the first plurality of threads comprises a percentage of the sum of the first and second plurality of threads ranging from about 70% to about 80%, or from about 80% to about 90%; and (3) adding color to a plurality of at least one of the first plurality of threads and the second plurality threads.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions and alterations herein without departing from the spirit and scope of the present disclosure.

What is claimed is:

1. An apparatus, comprising:
a plurality of first threads coupled to and extending from a substrate, wherein each of the plurality of first threads comprises a plurality of synthetic filaments, and each of the plurality of filaments comprises a plurality of synthetic microfibers; and
a plurality of second threads coupled to and extending from the substrate, wherein each of the plurality of second threads is adjacent to at least one of the plurality of first threads, and wherein each of the plurality of second threads does not comprise synthetic microfibers.

2. The apparatus of claim 1 wherein each of the plurality of second threads is adjacent to at least two of the plurality of first threads.

3. The apparatus of claim 1 wherein the plurality of first threads comprises about six first threads.

4. The apparatus of claim 1 wherein each of the plurality of first threads and each of the plurality of second threads extend to about a common distance from the substrate.

5. The apparatus of claim 1 wherein the plurality of first threads comprises between about 80% and about 90% of the sum of the plurality of first threads and the plurality of second threads.

6. The apparatus of claim 1 wherein the plurality of first threads comprises between about 70% and about 80% of the sum of the plurality of first threads and the plurality of second threads.

7. The apparatus of claim 1 wherein the plurality of first threads comprises about 85% of the sum of the plurality of first threads and the plurality of second threads.

8. The apparatus of claim 1 wherein the plurality of first threads comprises about 80% of the sum of the plurality of first threads and the plurality of second threads.

9. The apparatus of claim 1 wherein the plurality of first threads comprises about 75% of the sum of the plurality of first threads and the plurality of second threads.

10. The apparatus of claim 1 wherein the plurality of first threads comprises about 70% of the sum of the plurality of first threads and the plurality of second threads.

11. The apparatus of claim 1 wherein each of the plurality of second threads substantially comprises nylon.

12. The apparatus of claim 1 wherein each of the pluralities of first and second threads have first and second free ends and a central portion coupled to the substrate.

13. The apparatus of claim 1 wherein each of the plurality of synthetic microfibers substantially comprises polyester.

14. The apparatus of claim 1 wherein the plurality of synthetic microfibers comprises a plurality of bi-component microfibers.

15. The apparatus of claim 1 wherein the plurality of synthetic microfibers comprises a plurality of “islands in the sea” microfibers.

16. The apparatus of claim 1 further comprising a support material attached to the substrate opposite the pluralities of first and second threads.

17. The apparatus of claim 1 further comprising a support structure attached to the substrate opposite the pluralities of first and second threads.

18. The apparatus of claim 1 further comprising a substantially gloved-shaped support structure attached to the substrate opposite the pluralities of first and second threads.

19. The apparatus of claim 1 further comprising:
a first hook-and-loop fastener portion coupled to the substrate opposite the pluralities of first and second threads; and
a support structure comprising a substantially planar rectangular member and a second hook-and-loop fastener portion coupled to the member and configured to cooperate with the first hook-and-loop fastener portion to detachably couple the substrate with the support structure.

20. The apparatus of claim 1 wherein the substrate is one of a plurality of substantially tubular substrates and the pluralities of first and second threads extend radially outward from each of the plurality of substantially tubular substrates.

21. A method of manufacturing an apparatus, comprising:
processing a plurality of first threads, wherein each of the plurality of first threads comprises a plurality of synthetic filaments, wherein each of the plurality of synthetic filaments comprises a plurality of synthetic microfibers, and wherein processing the plurality of first threads comprises splitting each of the plurality of filaments to release the plurality of microfibers therein; and
coupling the plurality of first threads and a plurality of second threads to a substrate, wherein each of the plurality of second threads is adjacent to at least one of the plurality of first threads, and wherein each of the plurality of second threads does not comprise synthetic microfibers.

22. The method of claim 21 wherein each of the plurality of second threads is adjacent to at least two of the plurality of first threads.

23. The method of claim 21 wherein each of the pluralities of first and second threads has first and second free ends and a central portion coupled to the substrate, and wherein coupling the pluralities of first and second threads to the substrate comprises weaving each of the pluralities of first and second threads into the substrate.

24. The method of claim 21 wherein splitting each of the plurality of filaments comprises agitating the filaments in the presence of at least one of heat and a chemical solution.
